(19) United States
(12) Patent Application Publication
(10) Pub. No.: US 2011/0225633 A1
(43) Pub. Date: Sep. 15, 2011

(54) Data Processing Methods and Systems for Processing Data in an Operation having a Predetermined Flow Based on CAPTCHA (Completely Automated Public Test to Tell Computers and Humans Apart) Data, and Computer Program Products Thereof

(75) Inventor: Helen PAI, Cupertino, CA (US)

(73) Assignee: F2WARE INC., Cupertino, CA (US)

(21) Appl. No.: 13/047,546

(22) Filed: Mar. 14, 2011

(30) Foreign Application Priority Data
Mar. 15, 2010 (TW) 99107418
Aug. 31, 2010 (TW) 99129215

(51) Int. Cl. H04L 9/32; G06F 21/00

(52) U.S. Cl. 726/5

(57) ABSTRACT

Data processing methods and systems for processing data in an operation having a predetermined flow based on CAPTCHA (Completely Automated Public Test to tell Computers and Humans Apart) data are provided. First, a server generates a group of CAPTCHA data according to content of the operation. Then, the server transmits the group of CAPTCHA data to a client via a transmission medium. The client receives the group of CAPTCHA data via the transmission medium, inputs a first data corresponding to the operation using the CAPTCHA data and transmits the first data to the server via the transmission medium for verification, wherein the first data contains at least one CAPTCHA data.

### CROSS REFERENCE TO RELATED APPLICATIONS

This Application claims priority of Taiwan Patent Application No. 099107418, filed on Mar. 15, 2010 and Taiwan Patent Application No. 099129215, filed on Aug. 31, 2010, the entirety of which are incorporated by reference herein.

### BACKGROUND OF THE INVENTION

1. Field of the Invention

The disclosure relates generally to data processing methods and related data processing systems, and, more particularly to data processing methods and related data processing systems for processing data based on CAPTCHA (Completely Automated Public Test to tell Computers and Humans Apart) data that provide enhanced data protection for transmitted data.

2. Description of the Related Art

Recently, with the growth and development in network applications, the opportunity for users to access information through a network has been significantly increased. A user may utilize various electronic devices, such as computer systems, portable devices and so on, to perform a large number of services and applications through the network. In some network services, the user has to perform a registration procedure for the specific service or perform a confirmation procedure regarding some information. In the registration or the confirmation process, the user has to inspect related information provided by the server that provides the specific service and inputs related data based on the provided information for the registration or confirmation procedure.

Conventionally, information transmitted between a client and a server is transmitted by computer-based texts, which may easily be revised by malicious programs, e.g. viruses or wooden horse programs. Even if a virtual keyboard is utilized for inputting, the data inputted at the client side is still transmitted to the server by using computer-based texts. For example, input of the current transaction data may be made by a keyboard or a virtual keyboard that appears on the computer screen. The data that is selected at the client side and is to be transmitted to the server is still transmitted to the server by using computer-based texts for recognition of the transaction content.

To prevent personal data or content of operations from being tampered with or stolen by other unauthorized users, security strategies for data transmission between the server and the client have to be enhanced. It is therefore a desire to provide a method and system capable of ensuring that data transmitted between the server and the client are correct and are being protected when any operation is performed between the server and the client.

### BRIEF SUMMARY OF THE INVENTION

Data processing methods and data processing systems thereof are provided.

In an embodiment of a data processing method for processing data in an operation based on CAPTCHA (Completely Automated Public Test to tell Computers and Humans Apart) data, a server first generates a group of CAPTCHA data according to content of the operation. Then, the server transmits the group of CAPTCHA data to a client via a transmission medium. The client receives the group of CAPTCHA data via the transmission medium, inputs a first data corresponding to the operation using the CAPTCHA data and transmits the first data to the server via the transmission medium for verification, wherein the first data contains at least one CAPTCHA data.

An embodiment of a data processing system for performing an operation at least comprises a server and a client. The server generates a group of CAPTCHA data according to content of the operation and transmits the group of CAPTCHA data to a transmission medium. The client receives the group of CAPTCHA data via the transmission medium, inputs at least one first CAPTCHA data corresponding to the operation using the group of CAPTCHA data and transmits the first CAPTCHA data to the server via the transmission medium for verification.

Data processing methods and data processing systems thereof may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data processing system of the invention;

FIG. 2 is a schematic diagram illustrating an embodiment of an operation flow of the invention;

FIG. 3 is a schematic diagram illustrating an embodiment of CAPTCHA data of the invention;

FIG. 4 is a flowchart of an embodiment of a data processing method of the invention; and

FIG. 5 is a schematic diagram illustrating another embodiment of CAPTCHA data of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide data processing methods and related data processing systems for performing an operation between a server and a client based on CAPTCHA (Completely Automated Public Test to tell Computers and Humans Apart) data, wherein the server may convert a data set of information needed for a user to individual? CAPTCHA data and transmit the converted CAPTCHA data to the client via a transmission medium (e.g. a network). Moreover, the client may further divide each step in an operation into a number of smaller sub-steps, wherein each sub-step corresponds to a CAPTCHA data or a summary information thereof, and the CAPTCHA data or the summary information thereof is further transmitted to the server for data verification to verify whether the transmitted data is valid data so as to ensure that data sent by the client can be correctly received by the server, thereby preventing data from being tampered with by unauthorized users during the data transmission process.

In the embodiments, a data processing method is provided to apply a data encryption technique to data required for an operation (e.g. transaction information), wherein the encrypted data may be a watermark, a digital signature, one or more specific keys generated by a specific algorithm and so on. First, a server generates digital content that can be recognized by human users or computers, wherein information required for the transaction process are embedded into the generated digital content using a data encryption technique. The digital content may comprise any digital form of content, such as texts, image data, audio data, video data, bar codes and so on. Thereafter, the server transmits the digital content with embedded encrypted data to a client via the transmission medium. The client may then utilize the digital content with embedded encrypted data to input data of the operation for the transaction process and further transmit the digital content with embedded encrypted data to the server via the transmission medium. Finally, the server may apply one or more algorithms on the digital content with embedded encrypted data to obtain and identify data inputted for the operation, providing an efficient data processing method for ensuring data safety. It is to be understood that the transaction information differs from the transaction transmission in that the transaction transmission is similar to the digital certificate, wherein the client is capable of verifying a target of the server side.

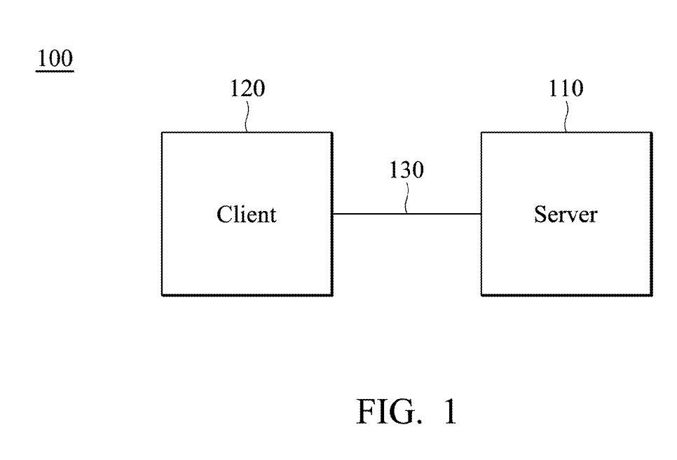

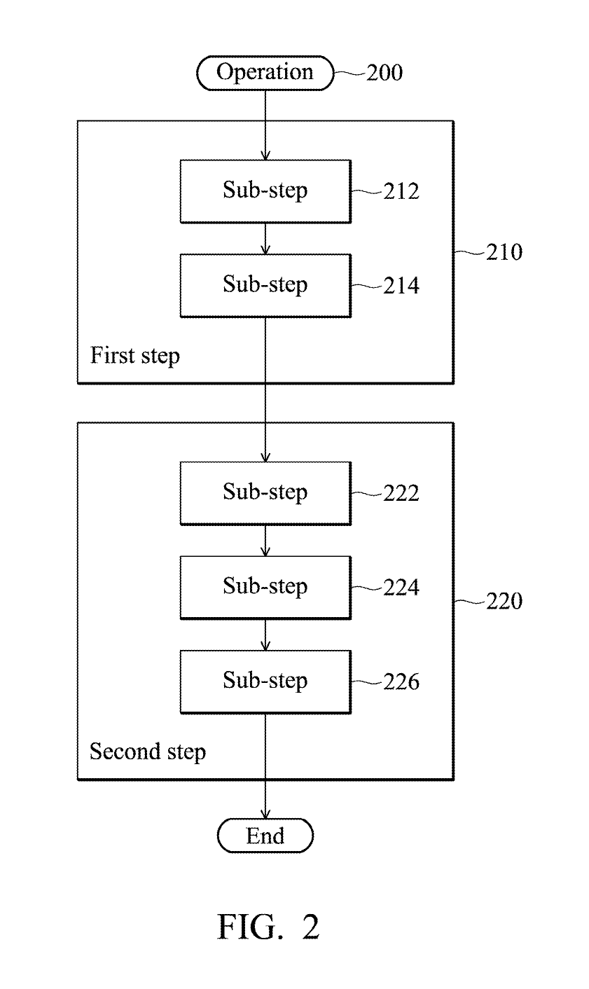

FIG. 1 is a schematic diagram illustrating an embodiment of a data processing system of the invention. The data processing system 100 at least comprises a server 110 and a client 120, wherein the server 110 may transmit data to the client 120 via a transmission medium, such as a network 130, for performing an operation between the server 110 and the client 120. In this embodiment, an operation may comprise one or more steps and the steps follow a predetermined execution flow. When the operation is performed, all of the steps corresponding thereto should be sequentially performed according to the predetermined execution flow. Each step may further be divided into one or more sub-steps and each sub-step has an input data corresponding thereto. For example, please refer to FIG. 2. FIG. 2 is a schematic diagram illustrating an embodiment of an operation flow of the invention.

As shown in FIG. 2, the operation 200 comprises a first step 210 and a second step 220, wherein the second step 220 is performed only after the first step 210 has been successfully and completely performed. Moreover, the first step 210 is divided into sub-steps 212 and 214 while the second step 220 is divided into sub-steps 222, 224 and 226. In this embodiment, when the operation 200 is performed, sub-steps 212, 214, 222, 224 and 226 are sequentially performed in order. Therefore, a whole operation is an irreversible process.

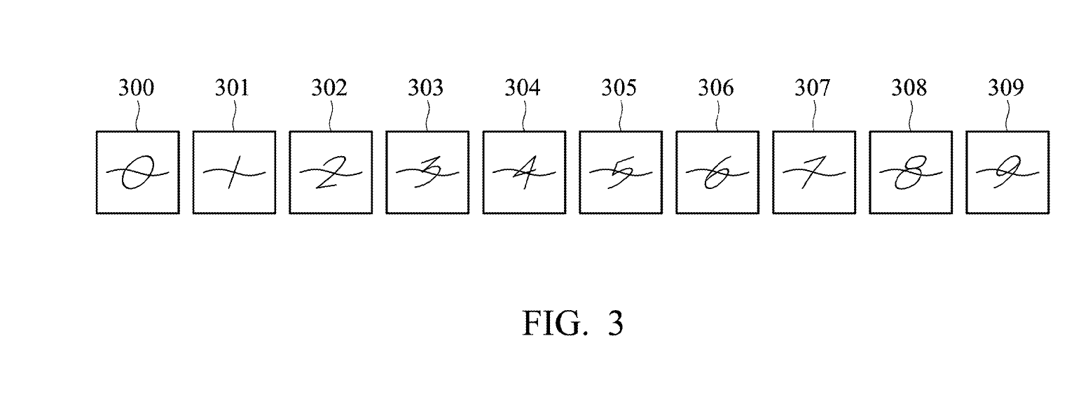

The transmission medium may comprise, for example but not limited to, the network 130. The network 130 may comprise wired or wireless networks, such as the INTERNET, but it is not limited thereto. The server 110 may convert data sets for information that is required by the operation to individual CAPTCHA data according to the content for the operation to be performed (e.g. data attributes for the operation) and transmit the converted CAPTCHA data to the client 120. In order to prevent input of a large number of malicious and repeated data caused by automatic programs or computers, the CAPTCHA technique can be utilized to distinguish between a computer or a human user by identifying whether the input is made by a human user or the input is automatically generated by a computer. Generally, the CAPTCHA process usually involves one computer asking a user to input letters or digits shown in a distorted image that other computers or automtic programs are supposedly unable to solve, such as an image with skewed and/or deformed letters or digits or an image with letters or digits including a line added thereon, so as to distinguish between whether the input (response) is made by a human user or by a computer. It is to be noted that, in this embodiment, the concept of CAPTCHA is applied to provide CAPTCHA data corresponding to data required by the operation. In operation, however, the user may also click and select data to be inputted from the CAPTCHA data through a user interface provided by the client 120, such as through a browser. For example but not limited to, in one embodiment, when the operation is a bank transfer operation for a net bank, the data required by the operation may comprise the account number and the amount transferred and thus the server 110 may respectively generate 10 CAPTCHA data 300-309 corresponding to digits 0-9, as shown in FIG. 3. The 10 CAPTCHA data shown in FIG. 3 will be transmitted to the client 120 for data inputting. It is to be noted that, in this example, the CAPTCHA data 300-309 are image data. However, in some embodiments, in addition to the image data, the CAPTCHA data may be video data or audio data.

Thereafter, the client 120 may receive and display the CAPTCHA data generated by the server 110 through the network 130 and then input corresponding data of each step using the received CAPTCHA data. Steps of the data processing method of the invention are detail described in the following.

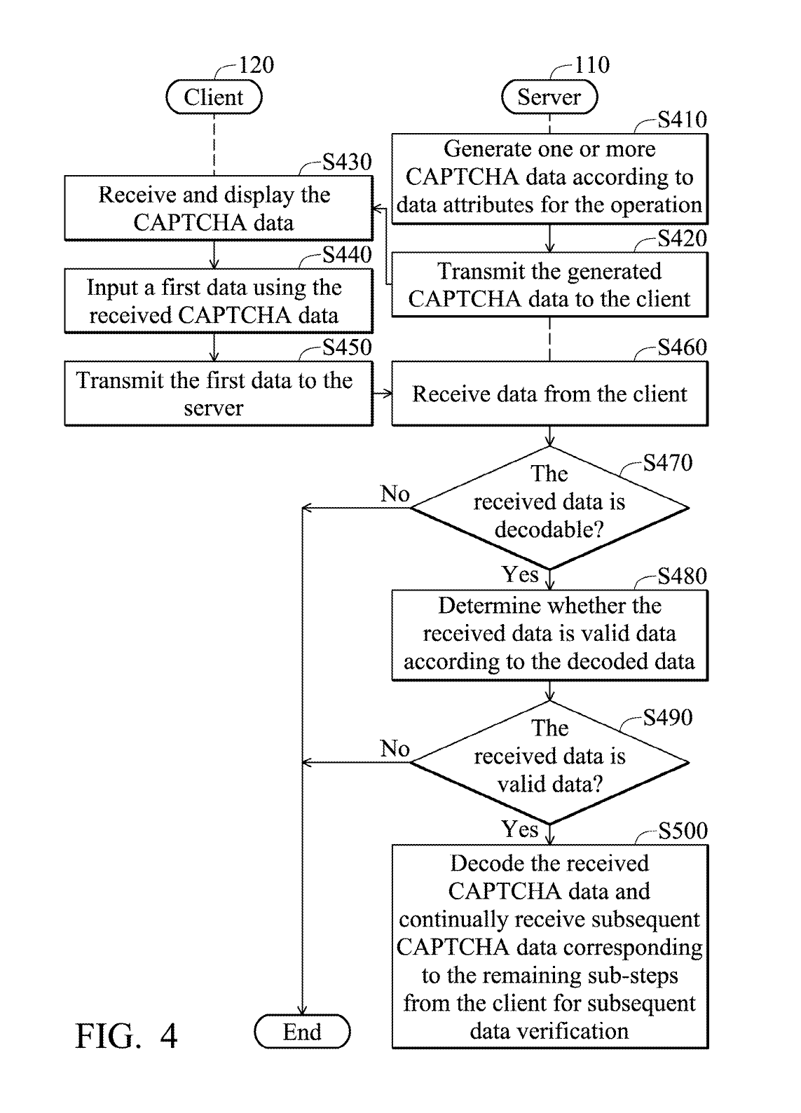

FIG. 4 is a flowchart of an embodiment of a data processing method of the invention. Please refer to FIGS. 1, 2 and 4. The data processing method of the invention is suitable for use in the data processing system 100 for performing an operation (e.g. the operation 200 as shown in FIG. 2). Similarly, the operation 200 comprises a first step 210 and a second step 220, wherein the second step 220 is performed only after the first step 210 has been successfully and completely performed. Moreover, the first step 210 is divided into sub-steps 212 and 214 while the second step 220 is divided into sub-steps 222, 224 and 226. When the operation 200 is performed, sub-steps 212, 214, 222, 224 and 226 are sequentially performed in this order.

First, in step S410, the server 110 generates one or more CAPTCHA data according to data attributes for the operation 200 and, in step S420, transmits the generated CAPTCHA data to the client 120. For example but not limited to, in one embodiment, when the operation is a bank transfer operation for a net bank, the data required by the operation may comprise the account number and the amount transferred data and thus the server 110 may respectively generate 10 CAPTCHA data corresponding to digits 0-9, as shown in FIG. 3. In another embodiment, if the account number comprises a combination of the letters of the alphabet and digits, the server 110 may generate 36 CAPTCHA data corresponding to alphabets A-Z and digits 0-9, respectively.

Thereafter, in step S430, the client 120 receives the CAPTCHA data from the server 110 and displays the CAPTCHA data and then, in step S440, inputs a first data using the received CAPTCHA data. In step S450, the client 120 transmits the first data to the server 110. Note that the first data may contain one or more CAPTCHA data and each step is divided into a plurality of sub-steps, wherein each sub-step corresponds to at least one CAPTCHA data. For example, if a step for inputting the amount of money is being performed, the user may input one of the digits of the amount of money by clicking and selecting the CAPTCHA data corresponding to the digit to be inputted, wherein each number of the amount of money can be served as a sub-step. When the user inputs a digit of the amount of money, the client 120 will transmit the corresponding CAPTCHA data or its summary information to the server 110 for verification to verify whether the inputted data is correct and has been successfully transmitted to the server 110.

In step S460, when receiving data from the client 120, the server 110 performs the verification procedure in steps S470 to S490 for data verification. In step S470, the server 110 first determines whether the received data is decodable. If the received data is not decodable (No in step S470), which means that data may not be generated by the server 110 and the data is possibly being revised, the server 110 ends the operation. When determining that the received data is decodable (Yes in step S470), in step S480, the server 110 decodes the received data to obtain a decoded data and then determines whether the received data is valid data according to the decoded data. In one embodiment, the server 110 may first obtain a watermark from the decoded data and then determine whether the received data is valid data based on the information and metadata hidden in the watermark. The server 110 may determine whether the received data is valid data by determining whether the data was sent by a specific user and whether the step/sub-step corresponding to the data is correct. The watermark data may further comprise user identification information and a step related information, such as a user identification code and a step identification code. The server 110 may determine whether the data was sent from a specific user and whether the step/sub-step corresponding to the data is correct based on the identification information and the step related information so as to determine whether the data is valid data. When both the user identification information and the step related information are correct, the server 110 determines that the received data is valid data. Otherwise, the server 110 determines that the received data is not a valid data.

When determining that the received data is not a valid data (No in step S490), which means that the data is possibly being revised, the server 110 ends the operation. Meanwhile, the user may be informed to re-input data or subsequent inputting by the user may be directly forbidden.

When determining that the received data is valid data (Yes in step S490), in step S500, the server 110 decodes the received CAPTCHA data to obtain a number “1” indicated by the received CAPTCHA data, continually receives subsequent CAPTCHA data corresponding to the remaining sub-steps and performs the data verification procedure in step S440 to S480 on the received data for subsequent data verification. If any invalid data is found during the data verification procedure, the operation will be ended. Therefore, important or sensitive data for the operation can be prevented from being tampered with, thereby ensuring operation safety.

The following illustrates some specific embodiments for further explanation of the aforementioned step S440. Those skilled in the art will understand that these specific embodiments are used for explanation only and the invention is not limited thereto. According to the data processing method of the invention, different types of first data can be inputted as input data based on the type of the operation to be performed. In other words, with the data processing method of the invention, the provided CAPTCHA data can be utilized to input different first data for different operations.

In some embodiments, when the operation to be performed is a bank transfer operation for a net bank, the inputted first data may comprise information corresponding to the bank transfer operation, such as the account number, the amount transferred, a name of the trading-partner, the currency unit to be transferred and so on.

In some embodiments, when the operation to be performed is a login operation, the inputted first data may comprise login related information for identity recognition, such as an account number and/or a password of a user and/or any other identity verification data required for the login operation.

In some embodiments, when the operation to be performed is a credit card online payment service, the inputted first data may at least comprise the credit card number and/or the card verification code of the card holder (e.g. the last three digits of the verification number that appears on the back of the credit card in the signature bar) or the likes. In another embodiment, the inputted first data may further comprise the identification card number of the card holder, including the Social Security Number (SSN) of the card holder.

In some embodiments, when the operation to be performed is a trading operation for a specific game, the inputted first data may at least comprise specific items used in the specific game, such as the value-added/transferred game cash points, the transfer account, the name of the trading item (including physical products and virtual products such as treasures for the specific game), the amount of the trading item and the trading price within the specific game and so on.

In some embodiments, when the operation to be performed is an operation corresponding to a user personal data, the inputted first data may at least comprise various personal data and contact data of that user, such as the phone number, the e-mail address, the fax number and/or the account for any network platforms of the user, e.g. the Twitter account, the Plurk account, the eBay account, the PayEasy account, the Facebook account or any similar personal network accounts.

In some embodiments, when the operation to be performed is an operation for inputting or modifying a one-dimensional/two-dimensional bar code, the inputted first data may at least comprise the product code data of one-dimensional bar code and/or two-dimensional bar code (e.g. a QR code) and/or related product information, wherein the product code data may comprise product codes that are commonly used, e.g. the European Article Number (EAN) and the Universal Product Code (UPC).

In some embodiments, when the operation to be performed is a file related operation, the inputted first data may at least comprise the file name to be uploaded/downloaded.

In some embodiments, when the operation to be performed is an operation relative to product transaction, the inputted first data may at least comprise the product name, the amount, the trading date, the identity of the receiver, the shipping address and the billing address for the product, etc.

In some embodiments, when the operation to be performed is a data maintenance operation, the inputted first data may at least comprise data to be inserted, modified and/or deleted and so on.

In one embodiment, the inputted first data may at least comprise information regarding the geographical locations or coordinates, such as the GPS coordinates information, the directional information (e.g. north, south, east and west) and so on. In another embodiment, the inputted first data may at least comprise the value of the Transaction Authentication Code (TAC), e.g. one time password (OTP), graphic one time password (GOTP), the TAN code, the TAC code and so on. In another embodiment, the inputted first data may further comprise the product number, the version number, the activation number and so on.

In some embodiments, after all of the sub-steps of one step (e.g. sub-steps 212 and 214 of the first step 210 shown in FIG. 2) have been performed and before a next step (e.g. the second step 220 shown in FIG. 2) is performed, the client 120 may simultaneously display (by an image) or play (by an audio data or a video data) CAPTCHA data corresponding to an operation result of the previous performed step. The user could further confirm that the previous step has been successfully performed and the check has passed by viewing the displayed data representing the operation result of the previous performed step. Thus, the next step is continually performed.

For explanation, one specific embodiment is illustrated in the following to explain the detailed process of a data processing method of the invention, and those skilled in the art will understand that this specific embodiment is used for explanation only and the invention is not limited thereto. In this embodiment, assuming that a bank transfer operation for a net bank is to be performed by the user and the bank transfer operation for a net bank comprises a first step-inputting the account number and a second step-inputting the amount transferred.

Please refer to FIGS. 1 to 4, the server 110 may first convert data sets for information that are required by the bank transfer operation of a net bank (i.e. the account number data and the amount transferred data) to corresponding CAPTCHA data. That is, the server 110 may respectively generate a group of CAPTCHA data (as the CAPTCHA data 300-309 shown in FIG. 3) corresponding to digits 0-9 of the account number data and the amount transferred data. Thereafter, the CAPTCHA data corresponding to digits 0-9 will be transmitted to the client 120 via the network 130 for user selection. The client 120 may display the CAPTCHA data generated by the server 110 and receive a CAPTCHA data selection for each sub-step of each of the steps. For example, if the user attempts to input an account number “1234”, the user may click and select the CAPTCHA data 301, 302, 303 and 304, which represent the number “1”, “2”, “3” and “4” respectively, in order. When the CAPTCHA data 301 is being selected, the client 120 may directly transmit the CAPTCHA data 301 to the server 110 or transmit a summary information corresponding to the CAPTCHA data 301 to the server 110 for data verification.

When receiving data from the client 120, the server 110 first determines whether the received data is decodable. If decoding of the received data fails, which means that data may be incorrect, the server 110 ends the operation. If the decoding of the received data is successful, the server 110 decodes the received data to obtain a decoded data, obtains a watermark embedded in the decoded data and then determines whether the received data is valid data based on the information and metadata hidden in the watermark. The information and metadata hidden in the watermark may comprise user identification information and a step related information, wherein the user identification information and the step related information may be utilized to verify whether the data was sent by a proper user and whether the step/sub-step corresponding to the data is correct. When both the user identification information and the step related information are correct, the server 110 determines that the received data is valid data; otherwise, it determines that the received data is not a valid data. If the step/sub-step or the user for the watermark is determined to be incorrect, which means that the data is possibly being revised, the server 110 ends the operation. When determining that the received data is valid data, the server 110 continually receives subsequent CAPTCHA data 302, 303 and 304 corresponding to the remaining sub-steps and performs the data verification procedure in step S440 to S480 on the received data for data verification. If any invalid data is found during the data verification procedure, the operation is ended.

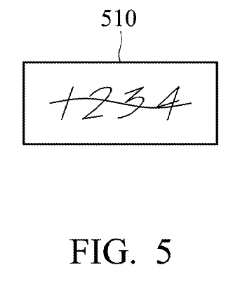

After all of the sub-steps of the first step have been performed and before the second step is performed, the server 110 may generate CAPTCHA data corresponding to an operation result of the first step and transmit the generated CAPTCHA data to the client 120. Upon reception of the CAPTCHA data corresponding to the operation result of the first step from the server 110, the client 120 may simultaneously display (by an image) or play (by an audio data or a video data) the CAPTCHA data corresponding to the operation result of the first step, such as the CAPTCHA data 510 shown in FIG. 5. The user could confirm whether the inputted data has successfully and correctly been received by the server 110 by viewing the account data represented by the CAPTCHA data 510. Thereafter, all of sub-steps of the second steps are sequentially performed until all of the steps for the operation haven been successfully performed.

In summary, in the development of electronic transaction applications in the past, a message hiding technique has never be applied in transmission of transaction content, e.g. the account number, the password, the amount transferred or other possible transaction data, and was only used for identifying whether a user is a specific user. For example, as an example of an image data, conventional message hiding techniques are only used for identifying whether a target is correct, but it does not apply to embedding any information required by the transaction process into the transaction process itself According to the data processing system and related data processing method of the invention, through inputting of CAPTCHA data and transmission of CAPTCHA data at the client side, a message hiding technique can be applied in transmission of content of an operation (e.g. transaction content), ensuring the data security for data transmitted between the client and the server and enhancing the safety for current transaction methods. Information required by the transaction process can be embedded into digital content at both the client and the server sides according to one or more algorithms such that data transmitted within the transaction process can be prevented from being revised by viruses or wooden horse programs, thus providing more data safety as compared with current transaction methods. Additionally, by dividing each step into a plurality of sub-steps with a smallest unit and inputting and verification thereby, all of the steps can be ensured to be irreversible and thus malicious data revising can be avoided.

Data processing methods and data processing systems thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data processing method for processing data in an operation having a predetermined flow based on CAPTCHA (Completely Automated Public Test to tell Computers and Humans Apart) data, comprising:
generating, by a server, a group of CAPTCHA data according to content of the operation;
the server transmitting the group of CAPTCHA data to a client via a transmission medium; and
the client receiving the group of CAPTCHA data via the transmission medium, inputting a first data corresponding to the operation using the group of CAPTCHA data and transmitting the first data to the server via the transmission medium for data verification,
wherein the first data contains at least one CAPTCHA data.

2. The data processing method as claimed in claim 1, wherein the operation comprises a plurality of steps and each of the steps is divided into a plurality of sub-steps, and the method further comprises:
in each sub-step of each of the steps, the client inputting the first data corresponding to the sub-step using the group of the CAPTCHA data and transmitting the first data to the server for data verification.

3. The data processing method as claimed in claim 1, wherein the operation at least comprises a first step and a second step, and the method further comprises:
after the first step has been successfully and completely performed, the server generates and transmits a first CAPTCHA data corresponding to an operation result of the first step to the client; and
when performing the second step, the client displaying or playing the first CAPTCHA data.

4. The data processing method as claimed in claim 3, wherein each of the group of CAPTCHA data or the first CAPTCHA data comprises an image data, an audio data or a video data.

5. The data processing method as claimed in claim 1, further comprising:
the server receiving the first data, obtaining a received data therefrom and determining whether the received data is decodable;
when determining that the received data is not decodable, the server ending the operation; and
when determining that the received data is decodable, the server obtaining a decoded data.

6. The data processing method as claimed in claim 5, further comprising:
the server determining whether the received data is valid data according to the decoded data; and
when determining that the received data is valid data, the server decoding the received data and continually receiving subsequent data from the client.

7. The data processing method as claimed in claim 6, wherein the step of the server determining whether the received data is valid data according to the decoded data further comprises:
the server obtaining a watermark or a summary information according to the decoded data and determining whether the received data is valid data using information corresponding to the obtained watermark or summary information.

8. The data processing method as claimed in claim 7, wherein the information corresponding to the obtained watermark at least comprises user identification information and a step related information.

9. The data processing method as claimed in claim 8, wherein the step of the server determining whether the received data is valid data using information corresponding to the obtained watermark further comprises:
when the user identification information and the step related information are correct, determining that the received data is valid data.

10. The data processing method as claimed in claim 1, wherein the operation comprises a bank transfer operation for a net bank and the first data comprises at least one of the account number, the amount transferred, a name of the trading-partner and the currency unit to be transferred.

11. The data processing method as claimed in claim 1, wherein the operation further comprises a login operation and the first data comprises an account number and/or a password of a user and/or any other identity verification data required for the login operation.

12. The data processing method as claimed in claim 1, wherein the first data comprises at least one of the credit card number, the card verification code and the identification card code of the card holder.

13. The data processing method as claimed in claim 1, wherein the operation comprises a trading operation for a specific game and the first data comprises at least one of the value-added/transferred game cash points, the transfer account, the name of the trading item, the amount of the trading item and the trading price within the specific game.

14. The data processing method as claimed in claim 1, wherein the operation comprises an operation corresponding to a user personal data and the first data comprises at least one of the phone number, the e-mail address, the fax number and the account for a network platform of the user.

15. The data processing method as claimed in claim 1, wherein the first data comprises at least one of the product code data of a one-dimensional bar code and/or that of a two-dimensional bar code and related product information, the file name to be uploaded/downloaded, the product name, the amount, the trading date, the identity of the receiver, the shipping address and the billing address for the product, the phone number, the e-mail address and the fax number of the user, data to be inserted, modified and/or deleted, information regarding the geographical locations or coordinates, and the value of the Transaction Authentication Code (TAC).

16. A data processing system for performing an operation, at least comprising:
a server, generating a group of CAPTCHA (Completely Automated Public Test to tell Computers and Humans Apart) data according to content of the operation and transmitting the group of CAPTCHA data to a transmission medium; and
a client, receiving the group of CAPTCHA data via the transmission medium, inputting at least one first CAPTCHA data corresponding to the operation using the group of CAPTCHA data and transmitting the first CAPTCHA data to the server via the transmission medium for verification.

17. The data processing system as claimed in claim 16, wherein the operation comprises a plurality of steps and each of the steps is divided into a plurality of sub-steps, and the client further inputs, in each sub-step of each of the steps, a first data corresponding to the sub-step using the group of the CAPTCHA data and transmits the first data to the server for data verification.

18. The data processing system as claimed in claim 16, wherein the operation at least comprises a first step and a second step, and the server further generates and transmits a first CAPTCHA data corresponding to an operation result of the first step to the client after the first step has been successfully and completely performed.

19. The data processing system as claimed in claim 18, wherein the client further receives the first CAPTCHA data and displays or plays the first CAPTCHA data when performing the second step.

20. The data processing system as claimed in claim 19, wherein each of the group of CAPTCHA data or the first CAPTCHA data comprises an image data, an audio data or a video data.

21. The data processing system as claimed in claim 16, wherein the server further receives the first data, obtains a received data therefrom and determines whether the received data is decodable, and the server ends the operation when determining that the received data is not decodable while the server obtains a decoded data when determining that the received data is decodable.

22. The data processing system as claimed in claim 21, wherein the server further determines whether the received data is valid data according to the decoded data and if so, decodes the received data and continually receives subsequent data from the client.

23. The data processing system as claimed in claim 22, wherein the server further obtains a watermark according to the decoded data and determines whether the received data is valid data using information corresponding to the obtained watermark.

24. The data processing system as claimed in claim 23, wherein the information corresponding to the obtained watermark at least comprises user identification information and a step related information.

25. The data processing system as claimed in claim 24, wherein the server further determines that the received data is valid data when the user identification information and the step related information are correct.

26. The data processing system as claimed in claim 16, wherein the operation comprises a bank transfer operation for a net bank and the first data comprises at least one of the account number, the amount transferred, a name of the trading-partner and the currency unit to be transferred.

27. The data processing system as claimed in claim 16, wherein the operation further comprises a login operation and the first data comprises an account number and/or a password of a user, and/or any other identity verification data required for the login operation.

28. The data processing system as claimed in claim 16, wherein the first data comprises at least one of the credit card number, the card verification code and the identification card code of the card holder.

29. The data processing system as claimed in claim 16, wherein the operation comprises a trading operation for a specific game and the first data comprises at least one of the value-added/transferred game cash points, the transfer account, the name of the trading item, the amount of the trading item and the trading price within the specific game.

30. The data processing system as claimed in claim 16, wherein the operation comprises an operation corresponding to a user personal data and the first data comprises at least one of the phone number, the e-mail address, the fax number and the account for a network platform of the user.

31. The data processing system as claimed in claim 16, wherein the first data comprises at least one of the product code data of one-dimensional bar code and/or that of two-dimensional bar code and related product information, the file name to be uploaded/downloaded, the product name, the amount, the trading date, the identity of the receiver, the shipping address and the billing address for the product, the phone number, the e-mail address and the fax number of the user, data to be inserted, modified and/or deleted, information regarding the geographical locations or coordinates, and the value of the Transaction Authentication Code (TAC).

32. A machine-readable storage medium comprising a computer program, which, when executed, causes a device to perform a data processing method for processing data in an operation having a predetermined flow based on CAPTCHA (Completely Automated Public Test to tell Computers and Humans Apart) data, and the method comprising:
receiving a group of CAPTCHA data from a server, wherein the group of CAPTCHA data are generated according to content of the operation;
inputting a first data corresponding to the operation using the group of CAPTCHA data; and
transmitting the first data to the server for data verification,
wherein the first data contains at least one CAPTCHA data of the group of CAPTCHA data.
